(19) United States
(12) Patent Application Publication
(10) Pub. No.: US 2016/0370986 A1
(43) Pub. Date: Dec. 22, 2016

(54) HAND-WRITTEN RECORDING DEVICE AND HAND-WRITTEN RECORDING METHOD

(71) Applicant: BOE TECHNOLOGY GROUP CO., LTD., Beijing (CN)

(72) Inventors: Ran Duan, Beijing (CN); Jibo Zhao, Beijing (CN)

(21) Appl. No.: 14/906,261

(22) PCT Filed: Aug. 17, 2015
(86) PCT No.: PCT/CN2015/087209

§ 371 Date: Jan. 19, 2016

(30) Foreign Application Priority Data
Jan. 21, 2015 (CN) 201510030550.2

(51) Int. Cl. G06F 3/0488; G06F 3/0346

(52) U.S. Cl. CPC G06F 3/04883; G06F 3/0346

(57) ABSTRACT

The present invention relates to a hand-written recording device and a hand-written recording method, the hand-written recording device comprising a sensing module for sensing real time location information of the hand-written recording device itself and a processing module for generating a moving track of the hand-written recording device based on the real time location information and generating storable information based on the moving track. Such a hand-written recording device does not have to rely on a bearing surface, which is convenient for the user to record information anytime and anywhere, increases flexibility for the user to record information significantly, and improves the user experience greatly.

### FIELD OF THE INVENTION

The present invention relates to the field of data processing technology, particularly to a hand-written recording device and a hand-written recording method.

### BACKGROUND OF THE INVENTION

In traditional techniques, the recording and storage of the texts and the patterns are generally only limited to such articles as pen and paper that can record entity texts. After improvement, the text and pattern recording or input technology in recent years can be performed by operating on an electronic element. For example, one can depict a track on a resistance screen or a capacitance screen (e.g., a tablet computer) through a pen or a finger, then the electronic component records the track and parses the track to obtain the corresponding texts or patterns.

In the recording manner of the prior art that relies on a bearing surface or a plane input, since the user is likely to perform some other operations in the process of depicting the track, the hand may produce motions unrelated to depicting the track. At this time, if all the tracks are recorded to form information, some wrong records may occur. Moreover, no matter the recording is performed using the pen and paper or the electronic element, a bearing surface (e.g., paper or screen) for input is always necessary. However, in case it is inconvenient for the user to carry these articles while there are still requirements for recording texts and patterns, it is apparently difficult for the recording manner of the prior art to meet the user's demands.

### SUMMARY OF THE INVENTION

The technical problem to be solved by the present invention is how to increase accuracy of recording the user input track, improve discrimination degree, allow the user to input texts or patterns out of the bearing surface, and record the user input content, thereby improving flexibility for the user to input texts and patterns and enhancing the user experience.

For this purpose, according to an aspect of the present invention, a hand-written recording device is proposed, which comprises a sensing module and a processing module, wherein the sensing module is used for sensing real time location information of the hand-written recording device itself and transmitting it to the processing module; the processing module is used for generating a moving track of the hand-written recording device based on the real time location information and generating storable information based on the moving track.

Preferably, in the hand-written recording device according to the present invention, the processing module is further used for, when it is determined to enter a plane recording mode based on an input instruction, determining a writing plane based on the real time location information and determining whether the hand-written recording device is in the writing plane: if it is determined that the hand-written recording device is in the writing plane, recording a moving track of the hand-written recording device based on the real time location information and generating storable information based on the moving track ; and if it is determined that the hand-written recording device is out of the writing plane, pausing the recording.

Preferably, in the hand-written recording device according to the present invention, the real time location information includes an angle of at least two displacements of the hand-written recording device and a linear acceleration and displacement time of each displacement, and the processing module is adapted for determining displacement vectors of the at least two displacements based on the linear acceleration of each displacement, the displacement time and the angle of the at least two displacements, and determining a writing plane based on the at least two displacement vectors and calculating a reference angle between the writing plane and the horizontal plane.

Preferably, in the hand-written recording device according to the present invention, the processing module is adapted for determining whether the hand-written recording device is out of the writing plane by calculating whether a difference value between the angle of the real time displacement vector of the hand-written recording device with the horizontal plane and the reference angle is within a preset angle range or whether the distance from the real time location of the hand-written recording device to the writing plane is within a preset distance range.

Preferably, in the hand-written recording device according to the present invention, the sensing module comprises: a gyroscope for sensing an angle of the two displacements; an acceleration sensor for sensing a linear acceleration and displacement time of each displacement.

Preferably, in the hand-written recording device according to the present invention, the processing module further comprises an identification sub-module for identifying the moving track as texts or patterns and taking the texts or the patterns as the storable information.

Preferably, in the hand-written recording device according to the present invention, it further comprises a storage module for storing the storable information.

Preferably, in the hand-written recording device according to the present invention, it further comprises a display module for displaying the storable information.

Preferably, in the hand-written recording device according to the present invention, it further comprises an input module for inputting instructions to the processing module. The input module for example comprises a keyboard or a touch screen.

Preferably, in the hand-written recording device according to the present invention, the processing module is further used for enabling the hand-written recording device to enter a sleep mode when it is determined that the hand-written recording device is out of the writing plane for a preset time length in a plane writing mode.

Preferably, in the hand-written recording device according to the present invention, it further comprises a transmitting module for transmitting the storable information to a designated terminal.

The hand-written recording device according to the present invention can move with the user hand, and can record the moving tracks of the user hand and parse the moving tracks to generate texts or patterns; when the user depicts tracks on a certain plane, effective tracks of the user in the writing plane can be recorded accurately, ineffective tracks of the user out of the writing plane can be omitted, so as to improve discrimination degree of the user depicted tracks; the user can also move in the air to generate tracks while not having to rely on an induction plane to input contents, which greatly improves flexibility for the user to input information and record information and promotes the user experience.

According to another aspect of the present invention, a hand-written recording method is provided, comprising the steps of: sensing real time location information of a hand for writing or a writing tool; generating a moving track of the hand based on the real time location information and generating storable information based on the moving track.

According to a further aspect of the present invention, another hand-written recording method is provided, the method comprising:

determining to enter a plane recording mode or a no-plane recording mode based on an input instruction;

in the case of determining to enter the plane recording mode: sensing first real time location information of the hand for writing or the writing tool;

determining a writing plane based on the first real time location information;

sensing second real time location information of the hand for writing or the writing tool;

determining whether the hand or the writing tool is out of the writing plane based on the second real time location information : if it is determined being out of the writing plane, pausing the recording; and if it is determined being not out of the writing plane, recording the second real time location information so as to form a moving track and generating storable information based on the moving track;

in the case of determining to enter the no-plane recording mode: sensing third real time location information of the hand for writing or the writing tool,

recording the third real time location information so as to form a moving track and generating storable information based on the moving track.

Preferably, in the hand-written recording method according to the present invention, the step of sensing the first real time location information comprises sensing an angle of at least two displacements of the hand or the writing tool and a linear acceleration and displacement time of each displacement, and the step of determining the writing plane based on the first real time location information comprises: determining displacement vectors of the at least two displacements based on the sensed linear acceleration of each displacement, the displacement time and the angle of the at least two displacements, and determining a writing plane based on the at least two displacement vectors and calculating a reference angle between the writing plane and the horizontal plane.

Preferably, in the hand-written recording method according to the present invention, the step of sensing the second real time location information comprises sensing a real time displacement vector and a real time location of the hand or the writing tool, and the step of determining whether the hand or the writing tool is out of the writing plane comprises: determining that the hand or the writing tool is out of the writing plane when a difference value between the angle of the real time displacement vector with the horizontal plane and the reference angle is not within a preset angle range or the distance from the real time location of the hand or the writing tool to the writing plane is not within a preset distance range.

### BRIEF DESCRIPTION OF THE DRAWINGS

The features and advantages of the present invention will be understood more clearly with reference to the drawings, the drawings are schematic while should not be construed as any limitation to the present invention, in the drawings:

FIG. 1 shows a schematic block diagram of a hand-written recording device according to an embodiment of the present invention;

FIG. 2A shows a schematic view of determining a writing plane in a plane recording mode by a hand-written recording device according to an embodiment of the present invention;

FIG. 2B shows a schematic view of determining in a plane recording mode by a hand-written recording device according to an embodiment of the present invention whether it is out of the writing plane;

FIG. 3 shows a schematic flow chart of a hand-written recording method according to an embodiment of the present invention;

FIG. 4 shows a schematic flow chart of a hand-written recording method according to another embodiment of the present invention; and

FIG. 5 shows a schematic flow chart of a hand-written recording method according to a further embodiment of the present invention in a plane recording mode.

### DETAILED DESCRIPTION OF THE INVENTION

In order to enable the readers to understand the above purposes, features and advantages of the present invention more clearly, next the present invention will be further described in more details with reference to the drawings and the specific implements. It should be noted that in the case of not conflicting, the embodiments of the present application and the features in the embodiments can be combined with one another.

A large number of specific details are expounded in the following description so as to understand the present invention sufficiently, however, the present invention can also be carried out using other manners different from those described here, hence, the protection scope of the present invention is not limited by the specific embodiments disclosed below.

FIG. 1 shows a schematic block diagram of a hand-written recording device according to an embodiment of the present invention. As shown in FIG. 1, a hand-written recording device 10 according to an embodiment of the present invention comprises a sensing module 11 and a processing module 13, wherein the sensing module 11 is used for sensing real time location information of the hand-written recording device 10 itself and transmitting the real time location information to the processing module 13; the processing module 13 is used for generating a moving track of the hand-written recording device based on the real time location information and generating storable information based on the moving track.

At work, the hand-written recording device 10 as shown in FIG. 1 can be worn on the hand, and moves together with the hand so as to record the moving track of the hand and thus obtain corresponding pattern or text information. The hand stated above can be one or more fingers, and can also be the palm, and can also be an entirety constituted by the finger(s) and the palm. Correspondingly, the hand-written recording device 10 specifically can adopt a product form for example a ring, a pen, a glove and so on integrated with the hand-written recording function. In addition, the hand-written recording device can establish a space rectangular coordinate system taking its initial location as the origin, and record its coordinates in the space rectangular coordinate system based on the real time location coordinates, so as to form the moving track.

In the present invention, the hand-written recording device 10 moving with the hand can capture pattern or text information written or inputted by the hand by recording the moving track of the hand-written recording device 10 itself (i.e., the hand moving together with it) in the case of not relying on the hardware such as a bearing surface or induction surface and a writing pen, thus it is convenient for the user to carry about, which requires no extra hardware storage space, and is convenient for the user to record and input information anytime and anywhere, thereby significantly increasing flexibility for the user to input and record information and improving the user experience greatly.

Preferably, as shown in FIG. 1, the processing module 13 can further comprise an identification sub-module 131 for identifying the moving tracks as texts or patterns, and taking the texts or patterns as the storable information.

Preferably, as shown in FIG. 1, the hand-written recording device 10 according to the embodiment of the present invention can further comprise a storage module 16 for storing the identified storable text or pattern information. The storage module 16 can be a nonvolatile or volatile memory, such as CD-ROM, RAM, flash memory, hard disk memory etc.

Preferably, as shown in FIG. 1, the hand-written recording device 10 according to the embodiment of the present invention can further comprise a display module 14 for displaying the storable information. The display module 14 can be a liquid crystal display or can also be a holographic projector.

Preferably, as shown in FIG. 1, the hand-written recording device 10 according to the embodiment of the present invention can further comprise an input module 12 for inputting instruction to the processing module 13. The input module 12 can comprise a keyboard, a mouse or a touch screen etc.

In addition, the hand-written recording device 10 according to the embodiment of the present invention can further comprise a transmitting module 15, such as a wireless or wired communication interface, for transmitting the obtained storable recording information to other terminals.

As stated above, in fact, since the manner of capturing the inputted information based on the space moving track of the hand is unrelated to the bearing surface, the hand-written recording device 10 according to the present invention apparently can support various recording modes, including the conventional recording mode that relies on the bearing surface and the no-bearing surface recording mode. The bearing surface recording mode refers to a mode that the user writes or records information on a certain bearing surface (such as the conventional recording medium of paper or electronic touch screen), wherein the bearing surface can use a plane generally, such as a horizontally placed surface or a plane with a certain angle with the horizontal plane. Hereinafter, taking the plane recording mode as the example, the bearing surface recording mode will be discussed.

In an embodiment of the hand-written recording device 10 according to the present invention, the processing module 13 can be further used for, when it is determined to enter the plane recording mode base don the input instruction, determining a writing plane based on the received real time location information and determining whether the hand-written recording device 10 is in the writing plane: recording a moving track of the hand-written recording device based on the real time location information and generating storable information based on the moving track if it is determined that the hand-written recording device 10 is in the writing plane; pausing the recording if it is determined that the hand-written recording device 10 is out of the writing plane.

In the plane recording mode, generally, the hand-written recording device 10 needs to determine the writing plane firstly, then determine whether the hand (or the hand-written recording device 10 moving together with it) for writing is located on the writing plane, the writing track will be recorded only when it is located on the writing plane, thereby avoiding other non-writing actions of the hand or the hand-written recording device 10 out of the writing plane being determined wrongly as the writing track.

The contents or tracks hand-written recorded or inputted by the user are mainly classified into two kinds, i.e., texts and patterns, generally. Thus, in the hand-written recording device 10 according to the embodiment of the present invention, the step of generating storable information based on the track may comprise parsing the track using text identification algorithm or image identification algorithm, so as to obtain a computer readable or storable text or image information, for instance, the text content can be stored in txt format, the pattern content can be stored in png or jpg format.

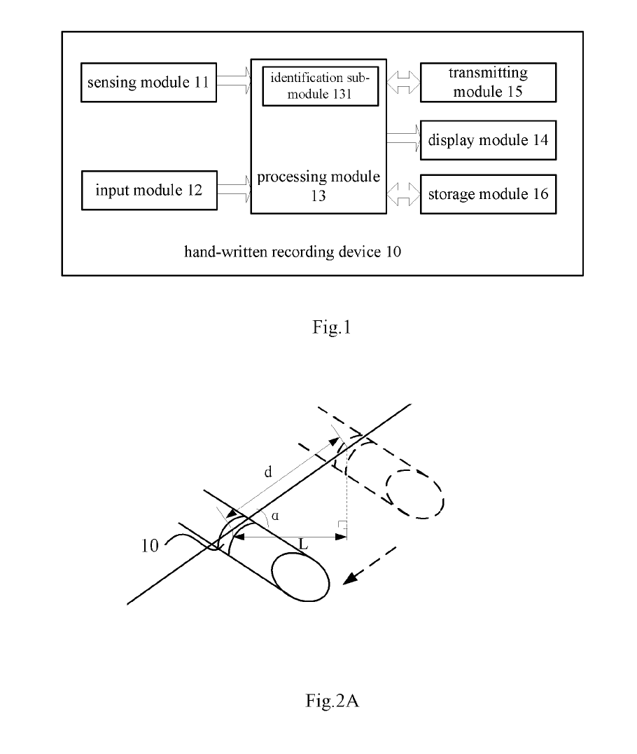

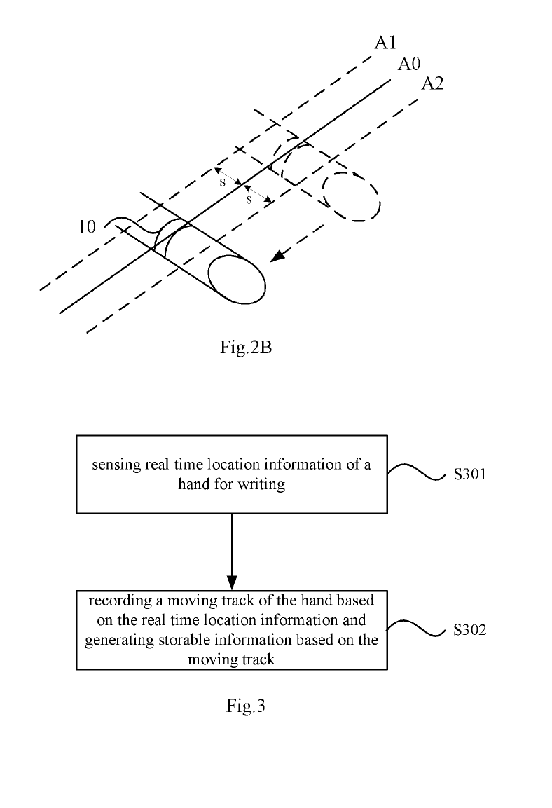

Preferably, in the plane recording mode, the principle for the hand-written recording device 10 determining the writing plane is as follows: determining a writing plane based on at least two displacements of the hand-written recording device. In an embodiment of the hand-written recording device 10 according to the present invention, the sensing module 11 can comprise a gyroscope for sensing an angle of the two displacements; an acceleration sensor for sensing a linear acceleration and displacement time of each displacement; and the processing module 13 can be further used for determining displacement vectors of the at least two displacements based on the linear acceleration of each displacement, the displacement time and the angle of the at least two displacements, and determining a writing plane based on the two displacement vectors and calculating a reference angle between the writing plane and the horizontal plane. Please refer to FIG. 2A for specific writing plane determining manner.

In the plane recording mode, after the writing plane is determined, it can be determined through basic mathematic knowledge whether the hand-written recording device or the hand for writing is out of the writing plane, for example, by determining whether its coordinates meet the equation of the writing plane. Whereas in actual operation, there may be certain error when the user begins to write in the air, here a certain threshold value can be set to increase the error-tolerant rate. Thus, in the present invention, the principle for determining whether the hand-written recording device 10 or the hand in contact with the writing plane for recording is out of the writing plane is as follows: when the difference value between the angle of the real time displacement vector of the hand-written recording device 10 or the hand with the horizontal plane and the reference angle is not within the preset angle range or the distance of its real time location to the writing plane is not within the preset distance range, determining that it is out of the writing plane. Please refer to FIG. 2B for specific determining method.

FIG. 2A shows a schematic view of determining a writing plane in a plane recording mode by a hand-written recording device according to an embodiment of the present invention. As shown in FIG. 2A, the hand-written recording device 10 for example is made in the form of a ring 10 which is worn on the finger of the user. However, the hand-written recording device 10 can also use other forms actually, such as glove, writing pen etc. A function key can be arranged on the hand-written recording device 10, and it is enabled to enter the writing plane determining function by clicking (or long pressing) the key. As shown in FIG. 2A, after entering the writing plane determining function, the hand-written recording device 10 moves two times with the user finger, the direction and the distance of the displacement can be determined based on the linear acceleration and the displacement time of each displacement, the relative relationship between two displacement can be determined based on the angle of the two displacements, and then a plane can be determined as the writing plane based on the two displacement vectors. Subsequently, the angle between the writing plane and the horizontal plane can be easily calculated based on the basic mathematic knowledge, e.g., according to the calculation formula of the angle between planes.

In addition, FIG. 2A further shows a positional relationship between the displacement vector of the hand-written recording device 10 and the horizontal plane. As shown in FIG. 2A, assume that the length of the displacement vector is d and the projection length of the displacement vector on the horizontal plane is L, based on the trigonometric function relationship, it can be derived that the angle between the displacement vector and the horizontal plane α=arccosL/d. The writing plane and the horizontal plane intersect on a straight line. When the displacement vector located in the writing plane is perpendicular to the straight line, the above angle between the displacement vector and the horizontal plane α=arccosL/d is namely the angle between the writing plane and the horizontal plane; and when the displacement vector is not perpendicular to the straight line, a first perpendicular line from a first endpoint of the displacement vector away from the straight line to the straight line can be made, at the same time, a second perpendicular line from the orthographic projection of the first endpoint on the horizontal plane to the straight line is made, the angle between the writing plane and the horizontal plane is determined by calculating the angle between the first perpendicular line and the second perpendicular line.

FIG. 2B shows a schematic view of determining in a plane recording mode by a hand-written recording device according to an embodiment of the present invention whether it is out of the writing plane. As shown in FIG. 2B, in the plane recording mode, the writing plane is A0, plane A1 and plane A2 are located above and under the writing plane A0 respectively, and their distances to the writing plane A0 are both s, thus, when the real time location of the ring 10 itself is between the plane A1 and the plane A2 (i.e., the distance from its real time location to the plane A0 is less than s) and the difference value between the angle of the displacement vector and the horizontal plane and the reference angle is within the preset angle range, it will be determined that the finger depicts tracks on the writing plane while being not out of the writing plane, here the moving track is recorded; otherwise, it will be determined that the finger is out of the writing plane, and the recording will be paused. The specific calculating method of the above determining condition is as follows: after the writing plane is determined, the distance from the real time location of the hand-written recording device or the ring 10 to the plane A0 can be calculated based on for example the distance formula of a point to the plane in the space analytic geometry, and the angle between the displacement vector and the horizontal plane as well as the reference angle (i.e., the angle between the writing plane and the horizontal plane) can be derived from the above method with reference to FIG. 2A.

In the plane recording mode, in order to distinguish the plane determining function and the recording function, the user can arrange a functional key on the hand-written recording device 10, for instance, a first and a second keystrokes (wherein the second keystroke can be same as the first keystroke, and the user can input different instructions through different operating manners) are arranged respectively corresponding to the two functions. In the plane recording mode, when the hand-written recording device enters the recording function, the region where the user actually depicts tracks is basically fixed, however, the user is likely to perform other operations in the process of depicting the tracks, for instance, unconscious finger bending or being out of the writing plane, thereby causing the location of the hand-written recording device 10 to be changed, such that tracks unrelated to the desired input contents are depicted. If these unrelated tracks are also identified, some undesired information even wrong information will certainly be produced. Here, it can be determined whether the finger or the hand-written recording device is out of the plane according to the manner as shown in FIG. 2B, and only the hand moving tracks that are determined not out of the writing plane are recorded, thereby avoiding tracks formed due to misoperation of the user from being recorded, and improving consistency of the generated text or pattern information with the user actual intention.

The above examples are only used for describing one implementing mode of the present invention, but the present invention can also implement said operation through other hand-written articles, for example, the hand-written recording device 10 can be a glove. When the user wears such a glove to perform hand-written operation, the palm portion and/or the finger portion in the glove can move with the hand-written operation of the user, and the palm portion and/or the finger portion can be integrated with a sensing module 11, an input module 12, a processing module 13, a display module 14, a transmitting module 15 or a storage module 16 as shown in FIG. 1, so as to record the moving tracks and form text or pattern information. The hand-written recording device 10 may also comprise a plurality of sensing modules 11, arranged at a plurality of fingers and/or the palm portion respectively, and by sensing a plurality of moving tracks of each finger and/or palm, more complex text or pattern information is formed through synthesized processing of the processing module 13.

When the device 10 is a non-wearable article such as a pen, the user can carry it moving together with the hand, thereby enabling the sensing module 11, the input module 12, the processing module 13, the display module 14, the transmitting module 15 or the storage module 16 integrated therein to record the moving tracks, so as to form the text or pattern information.

After the hand-written recording device 10 according to the present invention generates information to be stored and displays it through the display module 14, the user can determine based on the contents displayed in the display module 14 whether the generated recording information is consistent with the content that the user himself actually wants to record. If not consistent, a further operation can be performed, for example, inputting a deletion instruction in the input module 12, certainly, the instruction can also be generated by depicting the tracks directly. For example, if a cross track is inputted or the hand-written recording device 10 is shaken back and forth (equivalent to inputting a round trip line track), the hand-written recording device 10 will delete the information to be stored, and wait the user to input again, if the user inputs a tick track, the hand-written recording device 10 will store the information to be stored.

Preferably, in an embodiment of the hand-written recording device 10 according to the present invention, the processing module 13 can be further used for enabling the hand-written recording device 10 entering a sleep mode when it is determined that the hand-written recording device 10 is out of the writing plane for a preset time length in a plane writing mode. For instance, after the user inputs a section of content, when the input may be paused due to other affairs while the recording function of the hand-written recording device 10 is not turned off, the hand-written recording device 10 can automatically sense whether its location is out of the writing plane for a long time, if yes, it enters the sleeping state, thereby saving energy for the hand-written recording device 10.

Through the above description, the hand-written recording device 10 according to the present invention can move with the user hand, and can record moving tracks of the user hand and parse the moving tracks to generate texts or patterns; when the user depicts tracks on a certain plane, effective tracks of the user in the writing plane can be recorded accurately, ineffective tracks of the user out of the writing plane can be omitted, so as to improve discrimination degree of the user depicted tracks; the user can also move in the air to generate tracks while not having to rely on an induction plane to input contents, which greatly improves flexibility for the user to input information and record information and promotes the user experience.

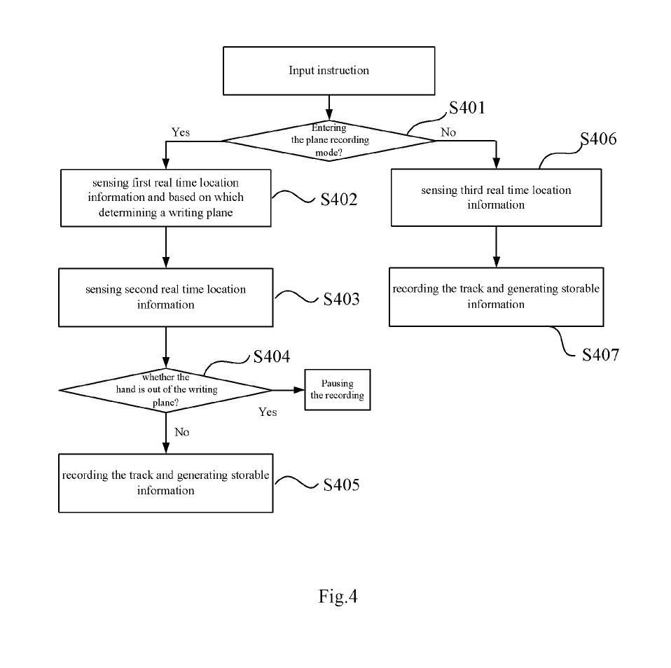

FIG. 3 shows a schematic flow chart of a hand-written recording method according to an embodiment of the present invention. As shown in FIG. 3, the hand-written recording method according to an embodiment of the present invention comprises: S301, sensing the real time location information of the hand for writing; S302, recording a moving track of the hand based on the real time location information and generating storable information based on the moving track.

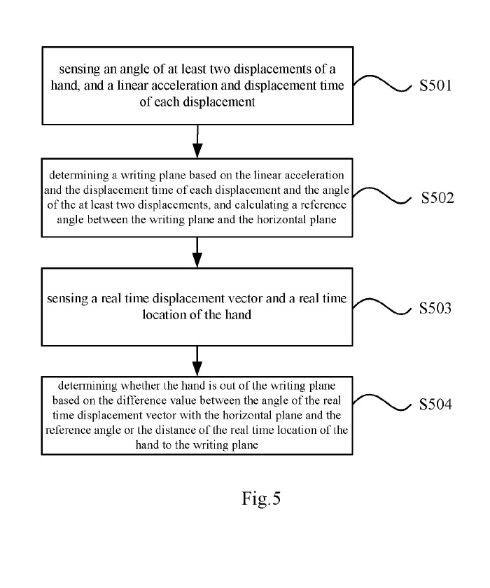

FIG. 4 shows a schematic flow chart of a hand-written recording method according to another embodiment of the present invention. The hand-written recording method as shown in FIG. 3 can be used for general hand-written recording mode, including bearing surface recording mode and no bearing surface recording mode. However, preferably, for the bearing surface (taking the plane as example here) recording mode, the hand or pen for writing needs to meet certain conditions in the writing process, i.e., being not out of the writing plane, otherwise, the recording will be ceased, thereby avoiding misjudgment caused by (e.g. subconscious) non-writing actions that may occur from influencing the accuracy of the information recording. Therefore, in the plane recording mode, the writing plane needs to be determined firstly, then it is determined whether the hand is out of the plane in the writing process based on the determined writing plane, and finally it is determined whether the information is recorded or the recording of the information is paused based on whether it is out of the plane or not. Specifically, the hand-written recording method as shown in FIG. 4 comprises:

S401, determining to enter a plane recording mode or a no-plane recording mode based on the input instruction; if it is determined to enter the plane recording mode, proceed to step S402, otherwise go to step S406;

S402, sensing first real time location information of a hand for writing or a writing tool, and determining a writing plane based on the first real time location information;

S403, sensing second real time location information of the hand for writing or the writing tool;

S404, determining whether the hand for writing or the writing tool is out of the writing plane based on the second real time location information, and pausing the recording if it is determined being out of the writing plane; go to step S405 if it is determined being not out of the writing plane;

S405, recording the second real time location information to form a moving track and generating storable information based on the moving track;

S406, sensing third real time location information of the hand for writing or the writing tool;

S407, recording the third real time location information to form a moving track and generating storable information based on the moving track.

FIG. 5 shows a schematic flow chart of a hand-written recording method according to a further embodiment of the present invention for use in a plane recording mode. As shown in FIG. 5, the hand-written recording method for use in a plane recording mode according to this embodiment comprises steps S501-504. The method can be divided into two parts, i.e., a part of determining a writing plane (S501-S502) and a part of determining whether the hand is out of the writing plane (S503-S504), they actually correspond to the steps S402 and S403-S404 as shown in FIG. 4, and further describe the specific performing manners of the corresponding steps in FIG. 4.

As shown in FIG. 5, the part of determining a writing plane (corresponding to the step S402 as shown in FIG. 4) comprises: S501, sensing an angle of at least two displacements of a hand for writing or a writing tool, and a linear acceleration and displacement time of each displacement; S502, determining displacement vectors of the at least two displacements based on the sensed linear acceleration and the displacement time of each displacement and the angle of the at least two displacements, and determining a writing plane based on the at least two displacement vectors and calculating a reference angle between the writing plane and the horizontal plane.

In addition, as shown in FIG. 5, the steps of determining whether the hand or the writing tool is out of the writing plane (corresponding to the steps of S403-S404 as shown in FIG. 4) comprise: S503, sensing a real time displacement vector and a real time location of the hand for writing or the writing tool; S504, determining that the hand or the writing tool is out of the writing plane when a difference value between the angle of the real time displacement vector with the horizontal plane and the reference angle is not within a preset angle range or the distance of the real time location of the hand or the writing tool to the writing plane is not within a preset distance range.

It should be pointed out that the hand-written recording method according to the embodiment of the present invention stated above is described by taking hand writing as the example. In fact, other tools, such as pen, glove etc., as stated above can also be used for writing.

The skilled person in the art should understand that the hand-written recording method according to the embodiment of the present invention can be carried out using the hand-written recording device according to the present invention, and can be carried out by using the functional components of the hand-written recording device according to the present invention to implement corresponding functions. However, other appropriate hand-written recording devices and functional components can also be used to carry out the hand-written recording method according to the embodiment of the present invention.

In the present invention, the terms of “first”, “second”, “third” are only used for the purpose of describing, and could not be construed as indicating or implying relative importance or order. The term “a plurality of” refers to two or more, unless otherwise specified.

What are stated above are only preferred embodiments of the present invention, but not used for limiting the present invention. For the skilled person in the art, the present invention may have various modifications and variations. Any modifications, equivalent replacements, and improvements and so on made within the spirit and principle of the present invention shall be covered within the protection scope of the present invention.

1. A hand-written recording device, comprising a sensing module and a processing module, wherein the sensing module is used for sensing real time location information of the hand-written recording device itself and transmitting it to the processing module; the processing module is used for generating a moving track of the hand-written recording device based on the real time location information and generating storable information based on the moving track.

2. The hand-written recording device according to claim 1, wherein the processing module is further used for, when it is determined to enter a plane recording mode based on an input instruction, determining a writing plane based on the real time location information and determining whether the hand-written recording device is in the writing plane: recording a moving track of the hand-written recording device based on the real time location information and generating storable information based on the moving track if it is determined that the hand-written recording device is in the writing plane; pausing the recording if it is determined that the hand-written recording device is out of the writing plane.

3. The hand-written recording device according to claim 2, wherein the real time location information includes an angle of at least two displacements of the hand-written recording device and a linear acceleration and displacement time of each displacement, and the processing module is adapted for determining displacement vectors of the at least two displacements based on the linear acceleration and the displacement time of each displacement and the angle of the at least two displacements, and determining a writing plane based on the at least two displacement vectors and calculating a reference angle between the writing plane and the horizontal plane.

4. The hand-written recording device according to claim 3, wherein the processing module is adapted for determining whether the hand-written recording device is out of the writing plane by calculating whether a difference value between the angle of the real time displacement vector of the hand-written recording device with the horizontal plane and the reference angle is within a preset angle range or whether the distance from the real time location of the hand-written recording device to the writing plane is within a preset distance range.

5. The hand-written recording device according to claim 3, wherein the sensing module comprises: a gyroscope for sensing an angle of the two displacements; an acceleration sensor for sensing a linear acceleration and displacement time of each displacement.

6. The hand-written recording device according to claim 1, wherein the processing module further comprises an identification sub-module for identifying the moving track as texts or patterns and taking the texts or the patterns as the storable information.

7. The hand-written recording device according to claim 1, further comprising a storage module for storing the storable information.

8. The hand-written recording device according to claim 1, further comprising a display module for displaying the storable information.

9. The hand-written recording device according to claim 2, further comprising an input module for inputting instructions to the processing module.

10. The hand-written recording device according to claim 6, wherein the input module comprises a keyboard or a touch screen.

11. The hand-written recording device according to claim 2, wherein the processing module is further used for enabling the hand-written recording device to enter a sleep mode when it is determined that the hand-written recording device is out of the writing plane for a preset time length in a plane writing mode.

12. The hand-written recording device according to claim 1, further comprising a transmitting module for transmitting the storable information to a designated terminal.

13. A hand-written recording method, comprising:
sensing real time location information of a hand for writing or a writing tool;
generating a moving track of the hand or the writing tool based on the real time location information and generating storable information based on the moving track.

14. A hand-written recording method, the method comprises:
determining to enter a plane recording mode or a no-plane recording mode based on an input instruction;
in the case of determining to enter the plane recording mode:
sensing first real time, location information of the hand for writing or the writing tool;
determining a writing plane based on the first real time location information;
sensing second real time location information of the hand for writing or the writing tool;
determining whether the hand or the writing tool is out of the writing plane based on the second real time location information, and pausing the recording if it is determined being out of the writing plane; recording the second real time location information so as to form a moving track and generating storable information based on the moving track, if it is determined being not out of the writing plane; and
in the case of determining to enter the no-plane recording mode:
sensing third real time location information of the hand or the writing tool,
recording the third real time location information so as to form a moving track and generating storable information based on the moving track.

15. The hand-written recording method according to claim 14, wherein the step of sensing the first real time location information comprises sensing an angle of at least two displacements of the hand or the writing tool and a linear acceleration and displacement time of each displacement, and the step of determining the writing plane comprises:
determining displacement vectors of the at least two displacements based on the sensed linear acceleration and the displacement time of each displacement and the angle of the at least two displacements, and determining a writing plane based on the at least two displacement vectors and calculating a reference angle between the writing plane and the horizontal plane.

16. The hand-written recording method according to claim 15, wherein the step of sensing the second real time location information comprises sensing a real time displacement vector and a real time location of the hand or the writing tool, and the step of determining whether the hand or the writing tool is out of the writing plane comprises:
determining that the hand or the writing tool is out of the writing plane when a difference value between the sensed angle of the real time displacement vector with the horizontal plane and the reference angle is not within a preset angle range or the sensed distance of the real time location of the hand or the writing tool to the writing plane is not within a preset distance range.
